(19) United States
(12) Patent Application Publication
(10) Pub. No.: US 2004/0146275 A1
(43) Pub. Date: Jul. 29, 2004

(54) Information processing method, information processor, and control program

(75) Inventors: Tomomi Takata, Ohta-ku (JP); Hidetomo Sohma, Ohta-ku (JP)

Correspondence Address: Canon U.S.A. Inc., Intellectual Property Department, 15975 Alton Parkway, Irvine, CA, 29618-3731, US

(73) Assignee: Canon Kabushiki Kaisha, Tokyo (JP)

(21) Appl. No.: 10/759,501

(22) Filed: Jan. 16, 2004

(30) Foreign Application Priority Data
Jan. 21, 2003 (JP) 2003/012511

(51) Int. Cl. H04N 5/76; G11B 27/00; G09G 5/00

(52) U.S. Cl. 386/52; 345/723

(57) ABSTRACT

The present invention provides an information processor for easily inserting a suitable transition clip between scenes for editing data. The information processor for editing input data performs an obtaining step of obtaining metadata of the data; a selecting step of selecting a transition clip used for adding a transition effect to the data based on the metadata; and a processing step of adding a transition effect to the data by using the transition clip.

### BACKGROUND OF THE INVENTION

1. Field of the Invention

The present invention relates to an information processing technology for editing or playing back data.

2. Description of the Related Art

Enhanced performance and lower cost of compact computer systems have promoted widespread use of home electric appliances having a computer used for control thereof or information processing. The uses of home video equipment have been changed from analog recording of broadcasted information and playback of video and music data supplied through media to recording of video and audio data in a form of digital data having high quality and durability. Also, compact and inexpensive video cameras which can be purchased by ordinary households have become common, and it is not uncommon sight that video recording is performed in the home so as to enjoy watching the recorded data.

Further, since computers and the Internet, which is a global network, have been widely used in homes, high-quality contents supplied in a form of digital data, such as video and audio data, can be dealt with more easily. Accordingly, multimedia data containing video, audio, and text data have been widely distributed.

In addition, people have more chances to do creative activities, as can be seen by many personal sites on the Internet.

Under these circumstances, users' need is more than recording data and watching supplied data, and their desire for performing video editing in the home has been growing, which has been conventionally performed by broadcasting companies or the like.

When video data is edited in the home, the video data may be edited while copying the data from a playback device to a recording device, for example, from a VTR to another VTR, or from a video camera to a VTR. In this method, a desired scene is searched for by fast-forwarding or rewinding a master tape for playback, and the video data is edited while copying the data to a recording tape. In this method, by using two or more playback devices or by using a video editing device or a computer device so as to copy data to a recording device, a special editing effect can be added to the video data, for example, a special transition effect can be inserted between scenes or a telop and caption can be synthesized into the video data. However, performing this technique requires experience in exclusive editing devices and editing, and also time and effort are needed. Therefore, it is difficult for amateur users to master this technique.

Recently, however, video data has been able to be taken into a computer device or the like so as to edit the video data by using a video capture card, an IEEE 1394 interface, a DV editing card, or the like. In this method, various editing effects can be added by using commercially available video editing software.

In particular, PCs having a good performance can be purchased in a reasonable price and PCs have become common in homes, and software having a professional editing function is available in the market. Therefore, editing methods using computer devices or the like have become mainstream.

Also, some of recently-available digital video cameras have a simple video editing function of, for example, adding a simple transition effect and inputting a title. In this type of video camera, various editing effects can be added during or after recording. In a method of editing data while copying it by using this type of video camera as a playback device, an editing effect can be added to the data without using a video editing device, for example, unnecessary part can be deleted or scenes can be rearranged.

In the future, the price of video cameras having an editing function will be reduced and an editing function will advance, so that video cameras having an editing function will be pervasive. Accordingly, users who cannot operate computers will be able to edit video data, and thus a video editing function will become familiar to more users.

With a growing demand for performing video editing in the home, an environment where video editing can be performed without a dedicated editing device is becoming a reality owing to a high-performance PC and video camera.

However, the following problems occur in the above-described known techniques. That is, expert knowledge and techniques are required to edit multimedia data, particularly video data, and complicated operation has to be performed. Therefore, editing video data recorded by a home video camera is still difficult for users who are not familiar with video editing.

As described above, an editing function of software for editing video data in a computer device and an editing function provided in a video camera have been improved so that amateur users can perform video editing relatively easily. However, users have to understand technical terms and have the know-how to edit data, and thus this type of software is not always easy to understand for beginners who don't have expert knowledge about video editing. Additionally, the edited data is not always satisfactory for the user.

Specifically, in an example of commercially available video editing software, a user can freely select and arrange scenes so as to connect the scenes, and a transition clip can be arbitrarily specified and inserted between scenes. Also, video cameras having an editing function of adding an arbitrary transition clip between scenes are available.

In the above-described method of arbitrarily selecting a transition clip, however, if a user is not familiar with video editing and does not have expert knowledge about editing, the user may be confused not knowing which clip should be inserted or the user may select a clip which is unsuitable for the theme or situation of scenes, so that unnatural video with excessive editing effects may be created.

Also, in another example of software for easily editing video data, templates of edit scenario in accordance with various themes (event information), such as a child's athletic festival, birthday party, and wedding ceremony, are prepared, and video data can be edited simply by taking recorded scenes from a video tape and arranging them. In this method, the user only has to arrange scenes in accordance with a specified order and no complicated operation is needed, and thus video editing can be performed relatively easily even by a beginner.

In this type of software, however, since situations and transition clips which can be inserted in each theme (event information) are specified by edit scenario, the edit freedom is restricted and user's personality cannot be expressed. Further, transition clips specified in edit templates do not always satisfy the preference and need of the user.

In addition, as described above, a transition clip can be inserted between scenes not only when two scenes are connected so as to create a sequence of video data but also when two or more scenes are played back sequentially. In that case, too, the above-described problems occur.

### SUMMARY OF THE INVENTION

The present invention has been made in view of the above-described problems and it is an object of the present invention to provide a method in which a user who does not have expert knowledge about editing can easily edit video data by inserting a transition clip between scenes.

It is another object of the present invention to provide a method in which a user who is not familiar with an editing technique can create sophisticated video including a video effect.

The present invention provides an information processing method for editing input data, including an obtaining step of obtaining metadata of the data; a selecting step of selecting a transition clip used for adding a transition effect to the data based on the metadata; and a processing step of adding a transition effect to the data by using the transition clip.

Further objects, features, and advantages of the present invention will become apparent from the following description of the preferred embodiments with reference to the attached drawings.

### BRIEF DESCRIPTION OF THE DRAWINGS

FIG. 1 is a block diagram showing the entire configuration of an information processing system including an information processor according to a first embodiment of the present invention.

FIG. 2 shows a screen used for instructing to insert a transition clip in the information processor according to the first embodiment.

FIG. 3 includes tables showing the relationship between video data and metadata attached thereto in the information processor according to the first embodiment.

FIG. 4 is a flowchart showing the entire process of inserting a transition clip in the information processor according to the first embodiment.

FIG. 5 is a flowchart showing a process of extracting potential transition clips in the information processor according to the first embodiment.

FIG. 6 is a flowchart showing a process of determining a transition clip in the information processor according to the first embodiment.

FIG. 7 shows the relationship between event information of metadata and transition clips in the information processor according to the first embodiment.

FIG. 8 shows information about each transition clip in the information processor according to the first embodiment.

FIG. 9 shows the relationship between metadata and meanings of each transition clip in the information processor according to the first embodiment.

FIG. 10 defines the correlation in metadata and features in the information processor according to the first embodiment.

FIG. 11 is a flowchart showing the entire process of inserting a transition clip in an information processor according to a second embodiment.

FIG. 12 is a flowchart showing a process of extracting transition clips which are unsuitable for transition of two scenes in the information processor according to the second embodiment.

FIG. 13 shows a screen for displaying an error message when an unsuitable transition clip is specified in the information processor according to the second embodiment.

FIG. 14 shows a screen used for instructing to insert a transition clip in an information processor according to a third embodiment.

FIG. 15 is a flowchart showing the entire process of inserting a transition clip so as to edit video data in the information processor according to the third embodiment.

FIG. 16 is a flowchart showing a process of extracting potential transition clips in the information processor according to the third embodiment.

FIG. 17 is a flowchart showing a process of extracting potential transition clips in the information processor according to the third embodiment.

### DESCRIPTION OF THE PREFERRED EMBODIMENTS

Hereinafter, embodiments of the present invention will be described with reference to the drawings.

<First Embodiment>

In this embodiment, video data input to a computer device is edited so as to set a transition effect (technique used for connecting scenes) between scenes.

In order to input video data recorded by a recording device such as a video camera into a computer device, for example, the video data stored in an external storage medium may be input to the computer device or may be input through a video capture card or an IEEE 1394 interface or the like. The input data may be stored in units of files, each including a clip (part or small unit of video) or a plurality of clips.

A transition effect can be set by using metadata attached to video data. The metadata includes contents of multimedia data and is used in an application such as search, the contents can being described based on a schema standardized by MPEG-7 or the like.

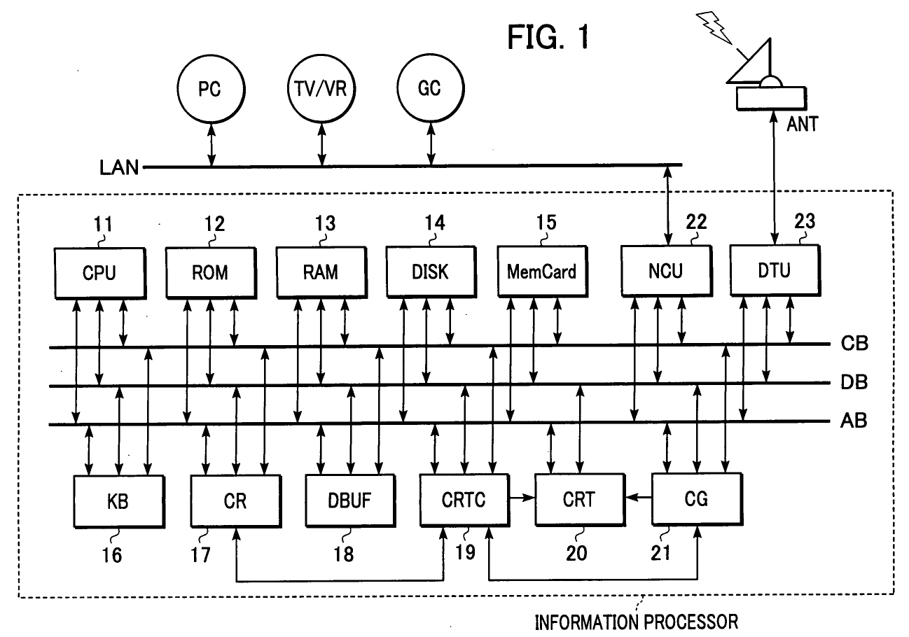

FIG. 1 shows an example of the entire configuration of an information processing system including an information processor according to an embodiment of the present invention.

In FIG. 1, the information processor includes a microprocessor (CPU) 11, which executes operations for various processes and logical decision and controls devices connected to an address bus AB, a control bus CB, and a data bus DB. The operations thereof are instructed by programs stored in a ROM 12 or a RAM 13, which will be described later. Also, a plurality of computer programs can be operated in parallel by using the function of the CPU 11 and the mechanism of the computer programs.

The address bus AB is used for transferring address signals for indicating devices to be controlled by the CPU 11. The control bus CB is used for transferring and applying control signals for devices to be controlled by the CPU 11. The data bus DB is used for transferring data among the devices.

The ROM 12 is a fixed read-only memory and stores control programs such as processing programs executed in this embodiment. Also, the ROM 12 stores a computer program area and a data area for storing the procedure of control executed by the CPU 11.

The recordable RAM 13 is used as the computer program area and the data area for storing the procedure of control executed by the CPU 11, and is also used as a temporary storage area for various computer programs and various types of data transmitted from the devices other than the CPU 11.

These storage media such as the ROM 12 and the RAM 13 store computer programs and data used for realizing data editing of this embodiment. The data editing function is realized when the CPU 11 reads and executes program codes stored in these storage media, but the type of storage media is not limited.

A recording medium containing the programs and data according to the present invention may be supplied to the system or the apparatus so as to copy the programs and data from the recording medium to a rewritable medium such as the RAM 13. In that case, a CD-ROM, a floppy (registered trademark) disk, a hard disk, a memory card, or a magnetooptocal disk can be used as the recording medium.

A hard disk (DISK) 14 functions as an external memory for storing various computer programs and data. The hard disk (DISK) 14 includes a storage medium which can read/write a large amount of information at a relatively high speed, and the various computer programs and data can be stored in and taken from the storage medium as necessary. The stored computer programs and data are entirely or partially invoked to the RAM 13 as required by a command input through a keyboard or instructions of the various computer programs.

As the recording media for storing these programs and data, a ROM, a floppy (registered trademark) disk, a CD-ROM, a memory card, or a magnetooptical disk can be used.

A memory card (MemCard) 15 is a removable storage medium. By storing information in this storage medium and connecting the storage medium to another device, the stored information can be referred to and transferred.

A keyboard (KB) 16 includes various function keys, such as alphabet keys, Hiragana keys, Katakana keys, punctuation/symbol keys, and cursor-movement keys for moving a cursor. Also, a pointing device such as a mouse may be included therein.

A cursor register (CR) 17 is also provided. Contents of the cursor register can be read/written by using the CPU 11. A CRT controller (CRTC) 19, which will be described later, displays a cursor in a display device (CRT) 20 at a position corresponding to an address stored in the cursor register.

A display buffer memory (DBUF) 18 stores patterns of data to be displayed.

The CRT controller (CRTC) 19 displays contents accumulated in the display buffer (DBUF) 18 in the display device (CRT) 20.

The display device (CRT) 20 includes a cathode ray tube, and the CRT controller 19 controls the display pattern of dot configuration and display of the cursor in the display device (CRT) 20.

A character generator (CG) 21 stores patterns of characters and symbols to be displayed in the display device (CRT) 20.

A communication device (NCU) 22 is used for communicating with another computer device or the like. By using the communication device (NCU) 22, the programs and data of this embodiment can be shared with other devices. In FIG. 1, the NCU 22 is connected to a personal computer (PC), a device (TV/VR) for receiving, storing, and displaying video data of television broadcast or video data taken by a user, and a home game computer (GC) through a network (LAN), so that information can be freely exchanged among these devices. Of course, any device may be connected to the apparatus of the present invention through the network. Also, the type of network is not restricted to the closed network as shown in FIG. 1, and the network may be connected to the external network.

A receiver (DTU) 23 realizes a receiving function of broadcast communication using an artificial satellite or the like, and has a function of receiving radio waves broadcasted through the artificial satellite by a parabolic antenna (ANT) and extracting broadcasted data. There are many types of broadcast communication: broadcast using ground waves; broadcast using coaxial cables and optical cables; broadcast using the LAN and a large-scale network, etc, but any type of broadcast communication may be adopted.

In the information processing system including the above-described devices, by connecting an IEEE 1394 terminal of a video camera or the like to an IEEE 1394 terminal (DV terminal) supplied from the communication device (NCU) 22, the video camera can be controlled by the computer device, video and audio data recorded in the video camera can be captured and taken into the computer device, and the data can be stored in the storage devices such as the ROM 12, the RAM 13, the hard disk (DISK) 14, and the memory card (MemCard) 15 shown in FIG. 1. Further, the data may be stored in another storage device through the LAN or the like so as to use the data.

The present invention can be realized by supplying a recording medium containing programs according to the present invention to the system or the apparatus so that a computer in the system or the apparatus reads and executes program codes stored in the recording medium.

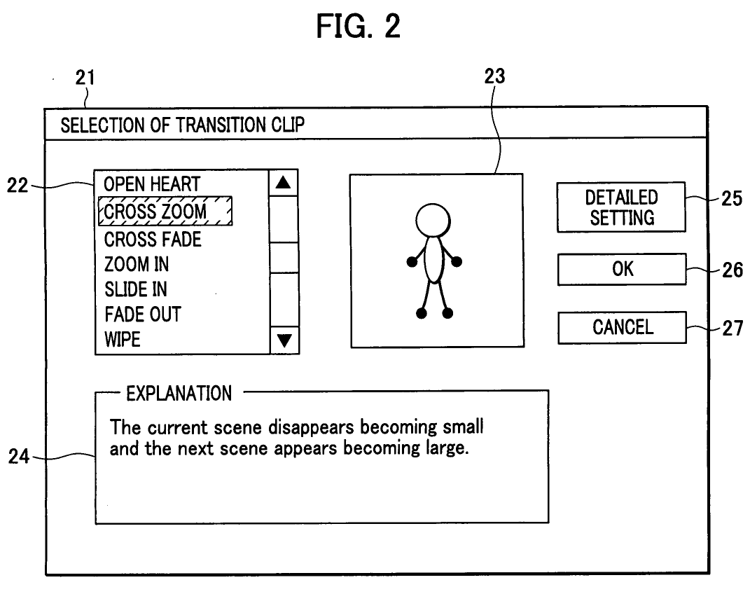

FIG. 2 shows an example of a screen in which a user selects a desired clip from among a plurality of transition clips, the process being illustrated in FIG. 6. This is an example when a window system is used, and this screen is displayed in the display device (CRT) 20 by the information processor of this embodiment.

In FIG. 2, reference numeral 21 denotes a title bar, which is used for operating the entire window, for example, for performing movement and changing the size.

Reference numeral 22 denotes a list box for displaying a list of transition clips which are suitable for transition of scenes specified by an operator. The operator can select a transition clip to be inserted. In FIG. 2, the list includes “open heart”, “cross zoom”, “cross fade”, and so on, and “cross zoom” is currently selected and is highlighted. When the operator presses a cursor-movement key on the keyboard (KB) 16, the highlight is shifted from “cross zoom” to “open heart” or “cross fade”. In this way, the operator can arbitrarily select a desired transition clip from the list.

An area 23 is used for displaying an image of a highlighted transition clip. The operator can check an image of transition of scenes by seeing animation sample.

An area 24 at the lower part of the screen is used for displaying the explanation of a highlighted transition clip in a text form. In FIG. 2, the currently-highlighted “cross zoom” is explained.

In this embodiment, the image and explanation of a transition clip are displayed at the same time, so that the user can easily understand what each transition clip is like. Animation samples and text to be displayed in the areas 23 and 24 are stored in a storage medium, such as the hard disk (DISK) 14 shown in FIG. 1. Alternatively, the samples and text may be stored in the PC on the LAN through the communication device (NCU) 22 or in a computer on the external network through the receiver (DTU) 23 shown in FIG. 1.

Buttons 25 to 27 can be pressed by operating the mouse or keys in the keyboard (KB) 16.

The button 25 is an detailed setting button, which is used by the operator to arbitrarily set detailed information such as the direction or length of a transition clip. A screen displayed when the detailed setting button is selected and detailed items which can be set are different depending on the type transition clip.

The button 26 is an OK button, which is used for finally confirming a currently-selected transition clip and input detailed information. When the OK button is selected, the transition clip which is currently highlighted in the list box 22 and the detailed information which has been input by pressing the button 25 are confirmed, and then the process proceeds to store the confirmed information.

The button 27 is a cancel button, which is used for canceling the input data.

In order to set a transition effect by using the information processor according to the present invention, metadata attached to video data is used. The metadata can be described in accordance with a method standardized by, for example, MPEG-7.

Hereinafter, the metadata attached to the video data in the information processor according to the present invention will be described.

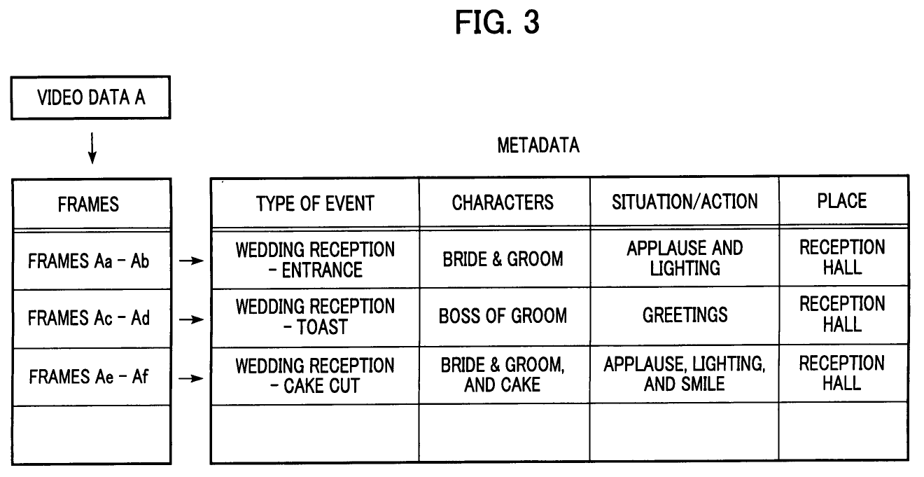

FIG. 3 shows an example of video data and metadata attached thereto. The figure shows that metadata is attached to a series of frames included in the video data. The metadata is information representing the contents and features of each piece of data, such as a type of event, characters (hereinafter, characters and objects related to an event will be referred to as “objects”), situation, and place. Herein, the contents and features of data are expressed by words (keywords) and character information (text) is mainly stored. However, free-form sentences, grammatically-analyzed sentences, and sentences including 5W1H may be also described. Also, information about the relationship between event information and objects, the relationship between scenes, information having a hierarchical structure and relative importance, and nonverval information in which the feature of data is described in a way the computer can easily process the information, can be attached.

Video data and the corresponding metadata are stored in a recording medium, such as the hard disk (DISK) 14 in FIG. 1. Also, data stored in the PC on the LAN can be used through the communication device (NCU) 22 and data stored in a computer on the external network can be used through the receiver (DTU) 23.

Now, a process of editing video data by using a transition clip in the information processor according to the present invention will be described with reference to a specific example.

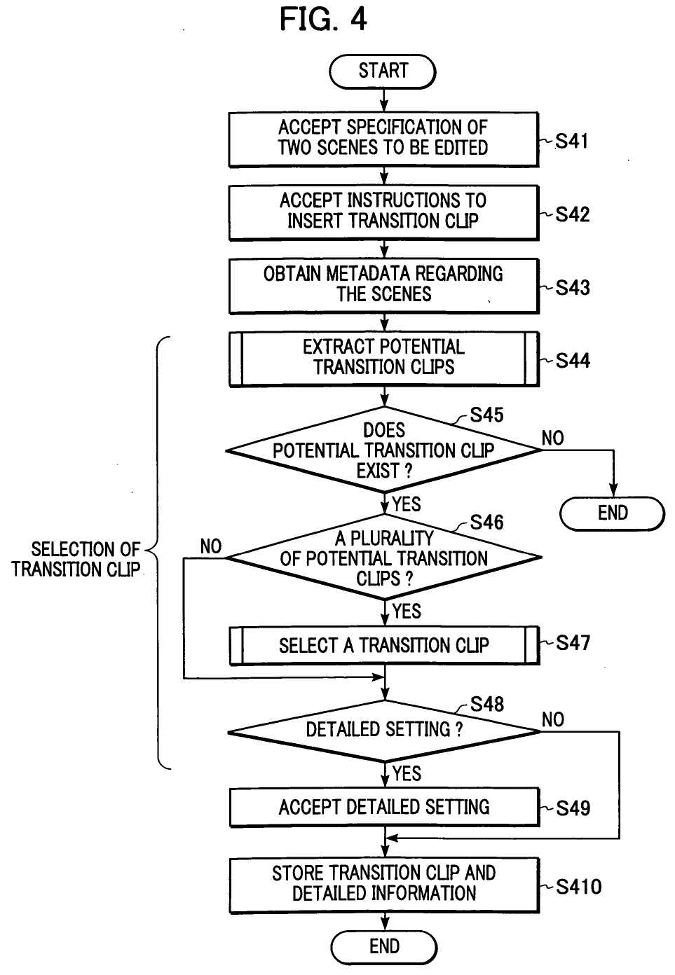

FIG. 4 is a flowchart showing a process of inserting a transition clip when video data is edited.

In step S41, specification of two scenes to be edited is accepted. The user can specify scenes and a transition clip by operating the keyboard (KB) 16 shown in FIG. 1 so as to specify each material (clip) and to place the clip on a time line or a story board by using video editing software or the like operated in the information processor of this embodiment. Further, a desired part can be extracted from a video clip by specifying the start and end points as necessary.

Herein, a scene means a section in the video data to be edited which the user wants to adopt, and is a minimum unit in data editing. Information about an edited scene can be represented by, for example, a frame ID of start and end points of a section which is adopted in a video clip.

The specified scenes are stored in a table holding a video editing status. The table includes information about video editing status, such as selected scenes, playback order of the scenes, and special effects including a telop and transition clip to be inserted into video. The table is stored in a recording medium such as the DISK 14 or the RAM 13 in FIG. 1.

In step S42, instructions to insert a transition clip between the scenes specified by the user are accepted.

In this embodiment, arbitrary two scenes are selected first and then a transition clip is set between the two scenes. Alternatively, all scenes to be used may be selected so as to decide the playback order, and then transition clips used for transition of scenes may be set.

In step S43, metadata corresponding to the two scenes sandwiching the point for a transition clip is obtained. An example of the metadata is shown in FIG. 3, which is stored in a recording medium such as the DISK 14 in FIG. 1. The obtained metadata is stored in a recording medium such as the RAM 13 in FIG. 1, and is used in step S44.

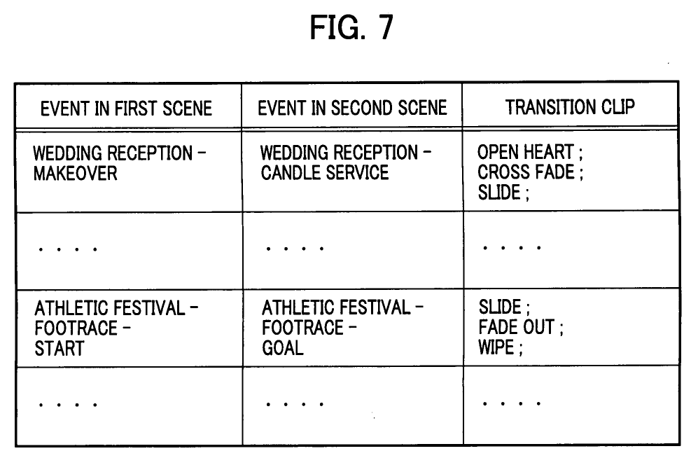

In step S44, the metadata obtained in step S43 is checked so as to obtain potential transition clips which are suitable for transition of the scenes. Potential transition clips can be obtained by referring to a table shown in FIG. 7, showing the relationship between event information of metadata attached to the two scenes and transition clips. For example, when event information in the metadata attached to a first scene is “reception-makeover” and when event information in the metadata attached to a second scene is “reception-candle service”, transition clips such as open heart, cross fade, and slide are searched for.

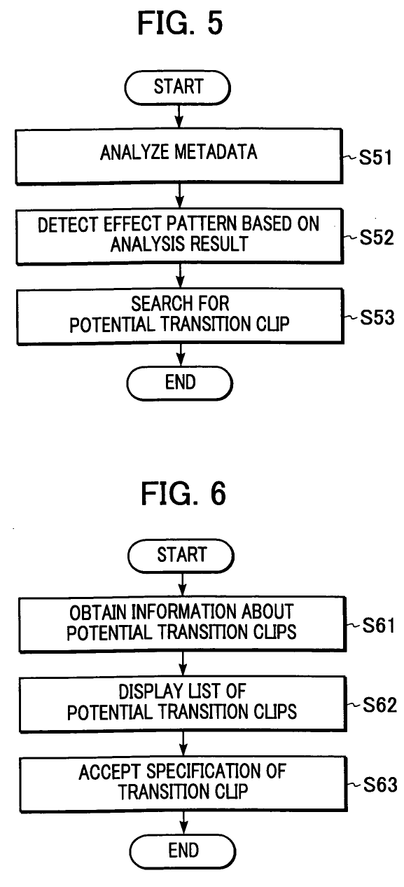

Alternatively, the relationship in the metadata attached to the specified scenes may be analyzed, and a suitable transition clip may be searched for based on the analysis result and on the meaning and effects of transition clips. The process performed in that case will be described later with reference to a flowchart shown in FIG. 5.

In step S45, it is determined whether or not a potential transition clip has been extracted in step S44. If a potential transition clip exists, the process proceeds to step S46, and otherwise, the process is completed.

In step S46, it is determined whether or not a plurality of potential transition clips exist. If a plurality of potential transition clips exist, the process proceeds to step S47, and if only one potential transition clip exists, the process proceeds to step S48.

In step S47, an optimal transition clip is selected from among the potential transition clips obtained in step S44. In this step, an optimal transition clip may be selected based on the importance, or the user may select a desired transition clip. The process in which the user selects a transition clip from among potential transition clips will be described later with reference to the flowchart shown in FIG. 6.

In step S48, it is determined whether or not setting of a detailed item has been instructed for the transition clip selected in step S47. If setting has been instructed, the process proceeds to step S49, and otherwise, the process proceeds to step S410. Setting of a detailed item is instructed by selecting the detailed setting button 25 shown in FIG. 2, whereby the operator can arbitrarily set detailed information such as the direction and length of the transition clip.

In step S49, a data processing system accepts setting of a detailed item by the user. The user operates the keyboard (KB) 16 so as to input detailed information regarding the transition clip. A screen displayed when detailed items are set and detailed items which can be set are different depending on the type of transition clip.

In step S410, the transition clip determined in step S47 and the detailed information input in step S49 are stored in a table holding a video editing status.

The edited data is processed by rendering based on the stored editing status, so that a final video file is automatically created based on video/audio files.

Next, another method for obtaining potential transition clips in step S44 in FIG. 4 will be described with reference to FIG. 5.

FIG. 5 is a flowchart showing step S44 in FIG. 4 in detail. In this process, the metadata of the scenes obtained in step S43 is checked so as to obtain potential transition clips suitable for the transition of the two scenes.

In step S51, the metadata attached to the video data is analyzed so as to determine the relationship between the two scenes in the entire story and the feature of each scene. FIG. 10 shows an example of a template defining the correlation among event information, pieces of sub-event information included in the event information, and objects in the metadata, and features of the event information and objects. The metadata can be analyzed by referring to these pieces of information. For example, in FIG. 10, when the event information representing a first scene is E2 and when the event information representing a second scene is E3, the first and second scenes have an R2 relationship. The relationship between the two scenes is not limited to only one, but the two scenes may have a plurality of relationships.

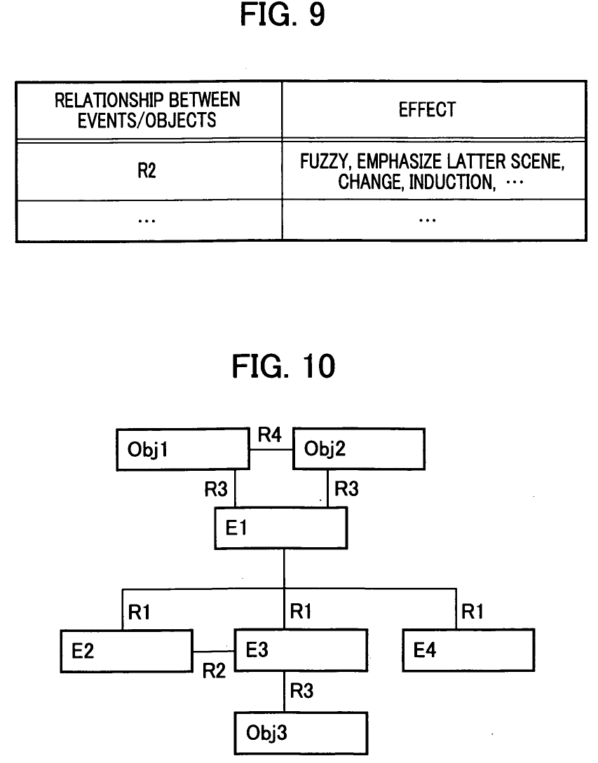

In step S52, meaning classification of transition clips suitable for transition of the two scenes is detected based on the analysis result of the metadata obtained in step S51. The table shown in FIG. 9 is stored in a storage device such as the DISK 14, the ROM 12, the RAM 13, or the MemCard 15 in FIG. 1, and shows the relationship between events-objects relationship and information in which transition clips are classified by meaning based on the impression and effect of each transition clip. By referring to this table, meaning classification of a transition clip corresponding to the relationship between the metadata attached to the two scenes is detected. For example, if relationship R2 has been obtained in the analysis in step S51, the meaning classification, such as emphasis, change, and induction, associated with R2 is detected. If the two scenes have a plurality of relationships, all meanings associated with the relationships are detected.

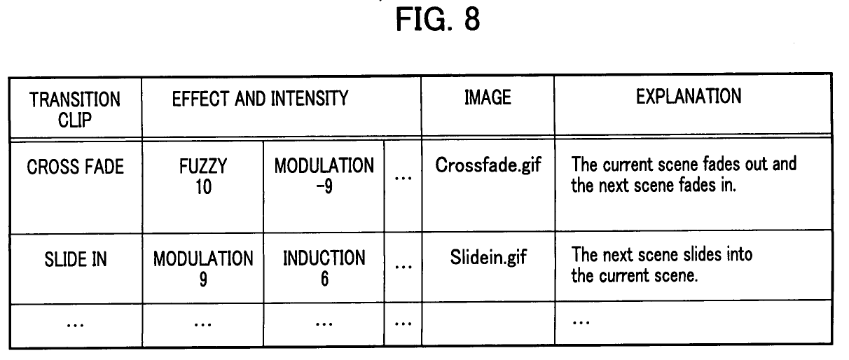

In step S53, a potential transition clip is searched for based on the meaning classification detected in step S52. FIG. 8 shows a table showing meaning classification and other information corresponding to the title of each transition clip. A potential transition clip is searched for by referring to this table. If a plurality of meanings have been detected, all transition clips to which the meanings are attached are searched for, and the sum thereof is regarded as a search result.

Next, a step of determining a transition clip in step S47 in FIG. 4 will be described with reference to FIG. 6.

FIG. 6 is a flowchart showing step S47 in FIG. 4 in detail. In this process, the user determines a desired transition clip from among the potential transition clips extracted in step S44.

In step S61, various pieces of information about the potential transition clips extracted in the process shown in FIG. 4 are obtained so as to use them in the DISK 14 and the RAM 13.

In step S62, the potential transition clips extracted in the process shown in FIG. 4 are displayed to the user. The list of the potential transition clips are displayed in, for example, the CRT 20. FIG. 2 shows an example of the displayed list. In this example, a window system is used, and a transition clip is to be inserted between the scene of makeover and the scene of candle service in video data obtained by recording a wedding reception.

In step S63, the data processing system accepts specification of a transition clip by the user. The user operates the keyboard (KB) 16 so as to specify a desired transition clip from among the potential transition clips displayed in step S62.

The transition clips are expressed by using technical terms, and thus they are difficult to understand for beginners who don't have expert knowledge about video editing. Therefore, it is desirable to present information about each of potential transition clips to the user so that the user can easily select a transition clip. For example, an image of changing scenes may be expressed by animation, or explanation of each transition clip may be displayed.

FIG. 7 is an example of a table showing the relationship between event information of metadata attached to two scenes and transition clips. In step S44 in FIG. 4, by checking the metadata of the two scenes by using this table, potential transition clips suitable for transition of the two scenes can be extracted. For example, FIG. 7 shows that transition clips such as open heart, cross fade, and slide are suitable for transition from makeover to candle service, which are sub-event information included in event information of a reception.

These pieces of information can be stored in the DISK 14 or the like shown in FIG. 1. In this embodiment, transition of scenes of home video contents can be appropriately performed by using a piece of event information as a unit. However, the method of the present invention can be applied to contents other than video contents by setting a reference unit depending on the type of contents.

FIG. 8 is a table showing information used for searching for potential transition clips. In this table, various pieces of information are attached to the title of each transition clip. For example, in this embodiment, the table includes information about effects of transition clips, which are classified based on impression and meaning of each transition clip, and intensity of impression and effects of each transition clip are indicated with values.

The intensity is represented by absolute values from 0 to 10, and a positive/negative sign represents the application state of effects. That is, when the intensity is represented by a positive number, association in the meaning is stronger (impression is more intense) as the number is larger. On the other hand, when the intensity is represented by a negative number, association is weaker (opposite meaning becomes stronger) as the number is larger. For example, “fuzzy” corresponding to a transition clip “cross fade” gives an impression (effect) to the user with an intensity of “10”. On the other hand, “modulation” is represented by a negative number, which means it gives an opposite impression (effect) to the user with an intensity of “9”.

Also, files and text used for displaying images and explanations of transition clips in the areas 23 and 24 in FIG. 2 are stored.

These pieces of information and files are stored in a recording medium such as the hard disk (DISK) 14 in FIG. 1. Further, the information and files may be stored in the PC on the LAN through the communication device (NCU) 22 or in a computer on the external network through the receiver (DTU) 23 in FIG. 1.

FIG. 9 shows an example of a table showing the relationship between events/objects in metadata and information obtained by classifying meanings of transition clips based on the impression and effect of each transition clip. By using such information, meaning classification suitable for transition of the two scenes can be detected based on the result of metadata analysis in step S52 in FIG. 5.

In FIG. 9, Rn (n is an integer) represents the relationship between pieces of event information En (n is an integer) or pieces of object information Objn (n is an integer), and meaning classification of transition clip is associated with each relationship.

For example, when two pieces of event information are associated with each other as “cause and effect” by relationship R2, the relationship between the two scenes can be impressed by a transition clip having meanings or effects of “emphasize the latter scene”, “change”, and “induction”.

These pieces of information can be stored in the DISK 14 or the like shown in FIG. 1. This embodiment is suitable for transition of scenes in video data or the like. However, the method of the present invention can be applied to data other than video data by selecting a transition effect corresponding to each type of data.

FIG. 10 shows an example of a template defining the correlation among event information in metadata, pieces of sub-event information included in the event information, and pieces of object information. By using these pieces of information, metadata is analyzed in step S51 in FIG. 5, so as to determine the relationship between two scenes in the entire story and the feature of each scene.

In FIG. 10, En (n is an integer) represents event information and Objn (n is an integer) represents object information. A piece of event information includes a plurality of pieces of event information having time and cause-effect relationships. Also, each piece of event information includes object information about people and objects related to the event. Every piece of event information has a relationship with another, and also every piece of object information has a relationship with another. Each relationship can be represented by Rn (n is a number). Further, each piece of event information and object information can have various features.

For example, in a wedding reception, event information E1 “wedding reception” is connected to sub-event information E2 “bride and groom in anteroom” and sub-event information E3 “entrance of bride and groom” by a relationship R1. Also, the sub-event information E2 and E3 of the event information E1 are connected by a relationship R2. Further, object information Obj1 “groom” and object information Obj2 “bride” in the event information are connected by a romantic relationship R4.

These pieces of information can be stored in the DISK 14 or the like in FIG. 1. In this embodiment, home video contents can be appropriately analyzed by using a piece of event information or object information such as characters as a unit. However, the method of the present invention can be applied to contents other than video contents by setting a reference unit depending on the type of contents.

In this way, the correlation among pieces of event information and object information and features of the information are defined in advance, and the information can be used for analyzing metadata.

As is clear from the above description, according to this embodiment, the user can easily select a transition clip which is the most suitable for the relationship, contents, time, and place of arbitrary two scenes based on the impression and meaning of each transition clip. Accordingly, even if the user does not have expert knowledge about editing, he or she can easily edit video data.

<Second Embodiment>

In the first embodiment, suitable potential transition clips are extracted based on metadata of multimedia data so as to select a transition clip from among them. Alternatively, unsuitable potential transition clips may be extracted based on metadata of multimedia data, and an error message may be generated when a user tries to select an unsuitable transition clip.

Hereinafter, a process of editing video data by using a transition clip in an information processor according to a second embodiment will be described with reference to a specific example.

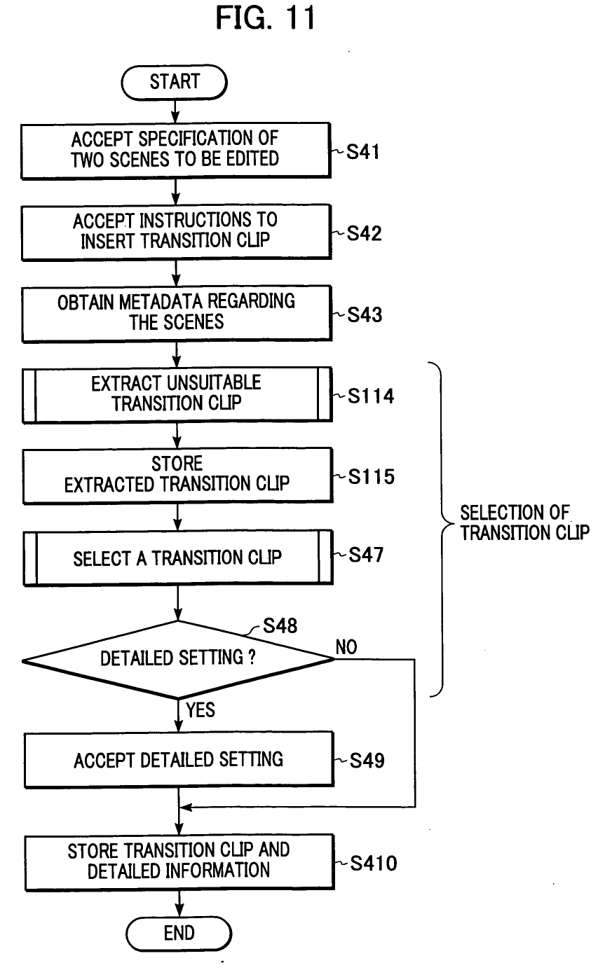

FIG. 11 is a flowchart showing a process of inserting a transition clip when video data is edited.

Steps S41 to S43 are the same as in the first embodiment, and thus the corresponding description is omitted.

In step S114, the metadata of the two scenes obtained in step S43 is checked so as to extract transition clips which are unsuitable for transition of the two scenes. An unsuitable transition clips can be extracted by referring to the table as shown in FIG. 7, as in the first embodiment. That is, unsuitable transition clips can be extracted by using a table indicating transition clips which are unsuitable for events in the two scenes.

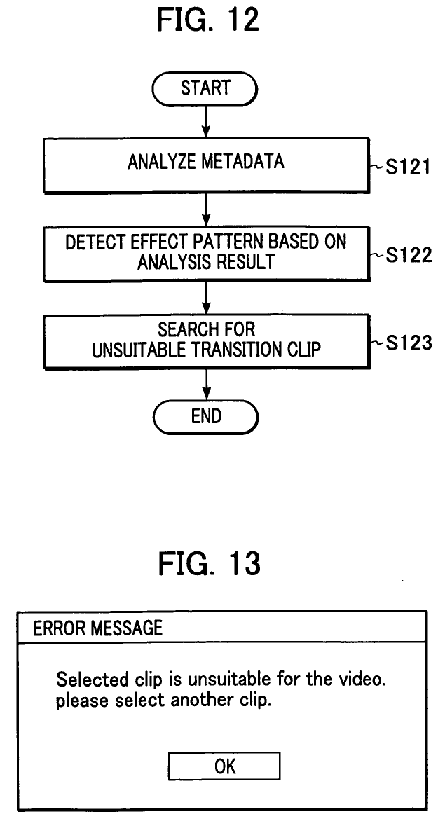

Alternatively, the relationship between the metadata attached to the specified scenes may be analyzed, and an unsuitable transition clip may be searched for based on the analysis result and on the meaning and effects of each transition clip. The process performed in that case will be described later with reference to a flowchart shown in FIG. 12.

In step S115, the transition clip(s) obtained in step S114 is (are) stored in a recording medium such as the RAM 13.

Steps S44 to S410 are the same as in the first embodiment, and thus the corresponding description is omitted.

FIG. 12 is a flowchart showing step S114 in FIG. 11 in detail. In this process, the metadata of the two scenes obtained in step S43 is analyzed and checked so as to extract a transition clip which is unsuitable for transition of the two scenes.

In step S121, the metadata attached to the video data is analyzed so as to determine the relationship between the two scenes in the entire story and the feature of each scene. As in the first embodiment, the metadata is analyzed by referring to the information shown in FIG. 10.

For example, in FIG. 10, when the event information representing a first scene is E2 and when the event information representing a second scene is E3, the first and second scenes have an R2 relationship. The relationship between the two scenes is not limited to only one, but the two scenes may have a plurality of relationships.

In step S122, meaning classification of transition clips suitable for transition of the two scenes is detected based on the analysis result of the metadata obtained in step S121. As in the first embodiment, by referring to the information shown in FIG. 9, meaning classification of a transition clip corresponding to the relationship between metadata attached to the two scenes is detected. For example, if relationship R2 has been obtained in analysis in step S121, meanings such as emphasis, change, and induction associated with R2 are detected. If there are a plurality of relationships between the two scenes, all the meanings associated with the relationships are detected.

In step S123, an unsuitable transition clip is searched for based on the meaning classification detected in step S122. As in the first embodiment, an unsuitable transition clip can be searched for by referring to the table shown in FIG. 8. For example, in FIG. 8, a negative sign attached to the intensity of a transition clip indicates an opposite impression and meaning. Therefore, when an unsuitable transition clip is extracted in this embodiment, all transition clips having an intensity of negative number corresponding to the detected meaning classification are searched for, and the sum is regarded as a result.

FIG. 13 is an example of an error message displayed when the user specifies an unsuitable transition clip from among a plurality of transition clips. This is an example when a window system is used, and this message is displayed in the display device (CRT) 20 by the information processor of this embodiment. By displaying such a message, the information processor notifies the user that the specified transition clip is unsuitable for transition of the scenes. When the user presses the OK button, this screen disappears, so that the user can specify a desired clip again from among transition clips displayed in a list by using a transition clip selection screen.

<Third Embodiment>

In the first embodiment, suitable potential transition clips are extracted based on metadata of multimedia data, and then an optimal transition clip is determined. Alternatively, suitability of each transition clip (value indicating suitability of each transition clip for edited frames) may be calculated and displayed based on metadata of multimedia data, so that the user can determine a transition clip by referring to the suitability. Hereinafter, a process of editing video data by using a transition clip in an information processor according to a third embodiment will be described with reference to a specific example.

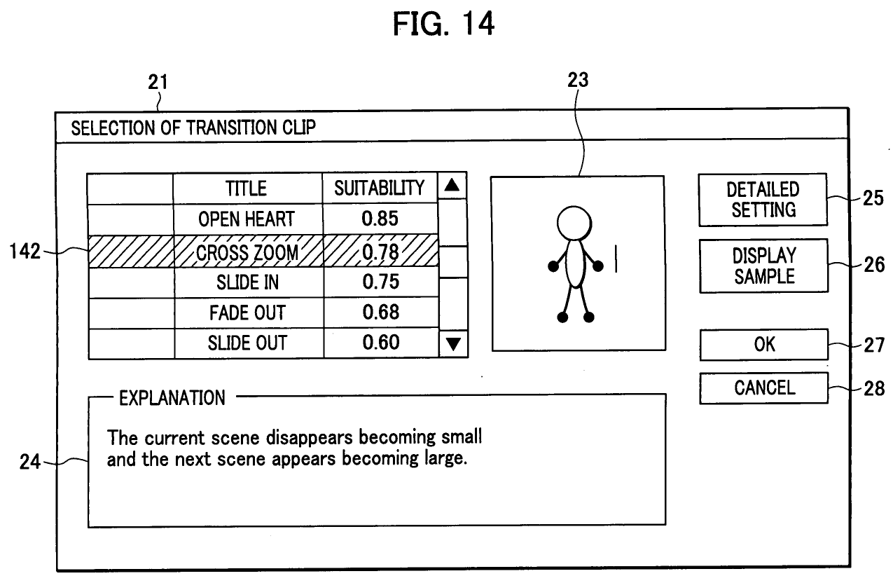

FIG. 14 is an example of a screen displayed when the user specifies a desired clip from among a plurality of transition clips in the process shown in FIG. 6. This in an example using a window system, and this screen is displayed in the display device (CRT) 20 by the information processor of this embodiment.

In FIG. 14, reference numerals 21 and 23 to 28 are the same as those in the first embodiment shown in FIG. 2, and thus the corresponding description will be omitted.

Reference numeral 142 denotes a list box. Transition clips suitable for transition of the scenes specified by an operator are displayed in this list box, so that the operator can specify a transition clip to be inserted. In the list box, the suitability of each transition clip is shown at the right side, and the user can check how much each transition clip is suitable for transition of the specified scenes.

In this embodiment, suitability is represented by decimal from 0 to 1, and the suitability is higher as the number is closer to 1. Also, all the transition clips found by search need not be displayed in the list box, but only transition clips having a predetermined suitability or top-10 transition clips in suitability ranking may be displayed. The transition clips are sorted in the descending ranking of suitability. In FIG. 14, the suitability of “open heart” is 0.85, that of “cross zoom” is 0.78, and that of “slid in” is 0.75. “Cross zoom” is currently selected and is highlighted. When the operator presses a cursor-movement key on the keyboard (KB) 16, the highlight is shifted from “cross zoom” to “open heart” or “slide in”. In this way, the operator can arbitrarily specify a desired transition clip in the list.

As in the first embodiment, metadata attached to video data is used for setting a transition effect in this embodiment. The metadata can be described in accordance with a method standardized by, for example, MPEG-7.

Next, a process of editing video data by using a transition clip in the information processor according to this embodiment will be described with reference to a specific example.

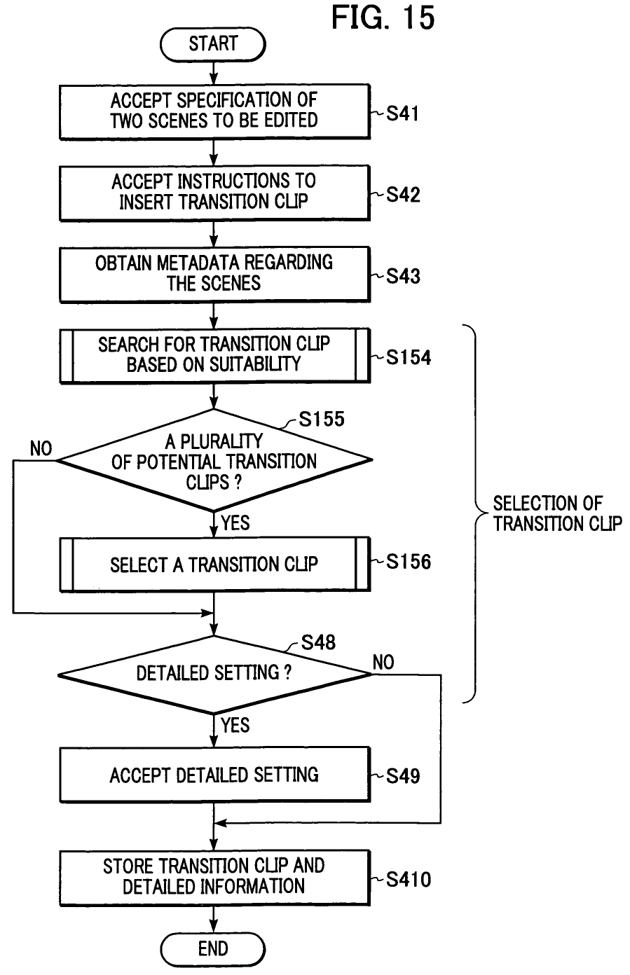

FIG. 15 is a flowchart showing a process of inserting a transition clip when video data is edited.

Steps S41 to S43 are the same as in the flowchart shown in FIG. 4 of the first embodiment, and thus the corresponding description will be omitted.

In step S154, the metadata of the two scenes obtained in step S43 is checked so as to search for a potential transition clip which is suitable for transition of the two scenes. When a potential transition clips is searched for, a suitable transition clip can be extracted by analyzing the relationship between metadata attached to the two scenes and calculating the suitability of each transition clip based on the analysis result, meaning and effect of each transition clip, and the importance. A process performed in that case will be described later with reference to the flowchart shown in FIG. 16.

In step S155, it is determined whether or not a plurality of transition clips have been obtained in step S154. If a plurality of transition clips have been obtained, the process proceeds to step S156, and if only one transition clip has been obtained, the process proceeds to step S48.

In step S156, an optimal transition clip is determined from among the transition clips obtained in step S154. A transition clip having the highest suitability may be selected in accordance with the suitability found in step S154. Alternatively, some transition clips having a predetermined suitability or some top-ranked transition clips may be presented to the user based on the result obtained in step S154, so that the user is allowed to select a desired transition clip from among these transition clips. A process of specifying a transition clip by the user is the same as that shown in FIG. 6 of the first embodiment, and thus the corresponding description will be omitted. Also, steps S48 to S410 are the same as in the flowchart shown in FIG. 4 of the first embodiment, and thus the corresponding description will be omitted.

FIG. 16 is a flowchart showing step S154 in FIG. 15 in detail. In this process, an optimal transition clip is determined by calculating the suitability of each transition clip based on importance.

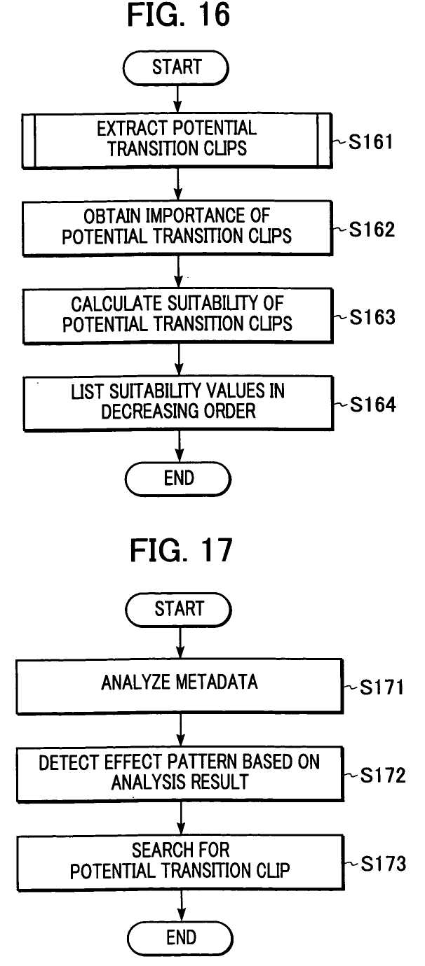

In step S161, the metadata of the two scenes obtained in step S43 in FIG. 15 is checked so as to extract potential transition clips suitable for transition of the two scenes. For example, the relationship between the metadata attached to the two scenes is analyzed, and then suitable transition clips can be searched for based on the analysis result and the meaning and effect of a transition clip. A process performed in that case will be described later with reference to the flowchart shown in FIG. 17.

In step S162, the intensity value corresponding to meaning classification detected in step S172 in FIG. 17 of each of the transition clips extracted in step S161 is obtained by referring to the table shown in FIG. 8. A plurality of meanings may be detected in step S172, and a plurality of meanings may be associated with a transition clip. Therefore, intensity values for all the meanings detected in step S172 are obtained. The obtained intensity values are stored in a work memory (not shown) in the RAM 13.

Then, in step S163, the suitability of each transition clip is calculated. First, the sum of the intensity values stored in the RAM 13 is obtained as suitability, and the suitability is stored in a region in the RAM 13 corresponding to each transition clip.

This process is performed for all the transition clips obtained in step S161. Then, in step S164, the values of suitability calculated for the transition clips are sorted in descending order.

A step of determining a transition clip in step S156 in FIG. 15 is the same as in the flowchart shown in FIG. 6 of the first embodiment, and thus the corresponding description will be omitted.

Next, a step of extracting potential transition clips in step S161 in FIG. 16 will be described in detail with reference to FIG. 17.

FIG. 17 is a flowchart showing step S161 in FIG. 16 in detail. In this process, potential transition clips suitable for transition of the two scenes are extracted by checking the metadata of the two scenes obtained in step S43 in FIG. 15.

In step S171, the metadata attached to the video data is analyzed so as to determine the relationship between the two scenes in the entire story and the feature of each scene. As in the first embodiment, the metadata is analyzed by referring to the information shown in FIG. 10. For example, in FIG. 10, the two scenes are connected by a relationship R2. The relationship between the two scenes is not always only one, but the two scenes may have a plurality of relationships.

In step S172, meaning classification of transition clips suitable for transition of the two scenes is detected based on the analysis result of the metadata obtained in step S171. As in the first embodiment, by referring to the information shown in FIG. 9, meaning classification of a transition clip corresponding to the relationship between metadata attached to the two scenes is detected.

For example, if relationship R2 has been obtained in analysis in step S171, meanings such as emphasis, change, and induction associated with R2 are detected. If there are a plurality of relationships between the two scenes, all the meanings associated with the relationships are detected.

In step S173, a potential transition clip is searched for based on the meaning classification detected in step S172. A potential transition clip is searched for by referring to the table shown in FIG. 8, as in the first embodiment. If a plurality of meanings are detected, transition clips corresponding to all the meanings are searched for, and the sum thereof is regarded as a search result.

As is clear from the above description, according to this embodiment, the user can easily understand the feature of each transition clip by indicating a suitability value, and thus the user can select a transition clip easily.

<Other Embodiments>

In the above-described embodiments, video data is used as accumulated information to be edited. However, the present invention can be applied to multimedia data other than video data, such as image data and audio data, by setting attached metadata, method for analyzing metadata, and a transition effect corresponding to the type of contents.

Also, in the above-described embodiments, suitable transition clips are extracted by analyzing the metadata shown in FIG. 3, that is, information indicating the contents of video data including keywords of event information, characters, situation, and place, by using the template showing the correlation between event information and object information of metadata shown in FIG. 10. Alternatively, transition clips can be extracted by attaching metadata describing the relationship between event information and objects to video data so as to use the relationship between metadata and meaning classification of transition clips shown in FIG. 9.

Also, transition clips can be extracted by attaching metadata describing the relationship between scenes to video data so as to define the relationship between the scenes and the relationship between transition clips (not shown).

Further, in the above-described embodiments, video data input to a computer device is edited so as to set a transition effect between scenes. However, the present invention may be realized as a part of video editing function provided in a recording device such as a video camera, so that a transition effect can be added during or after video recording. In that case, the metadata shown in FIG. 3, the information defining the correlation and features of event information and object information shown in FIG. 9, the information attached to a transition clip shown in FIG. 10, and so on must be stored in a storage device such as a DISK, ROM, RAM, or memory card of the recording device. These pieces of information can be obtained through a LAN or the like and stored in the storage device. The video data edited during recording is processed by rendering and is stored in the storage device of the video camera.

In the above-described embodiments, a transition effect is set between scenes so as to edit video data. However, the present invention can be applied when the video data is not edited or processed but a plurality of scenes are sequentially played back. In that case, too, a suitable transition effect can be inserted between scenes.

The present invention may be applied to a system including a plurality of devices (for example, host computer, interface device, reader, and printer) or may be applied to a single device (for example, copier or fax machine).

Of course, the object of the present invention can be achieved by supplying a storage medium (or recording medium) containing software program codes for realizing the function of the above-described embodiments to a system or apparatus so that a computer (or CPU or MPU) of the system or apparatus reads and executes the program codes stored in the storage medium. In this case, the program codes read from the storage medium realize the function of the above-described embodiments, and thus the storage medium storing the program codes is included in the present invention. As the storage medium for supplying the program codes, a floppy (registered trademark) disk, a hard disk, an optical disk, a magnetooptical disk, a CD-ROM, a CD-R, a magnetic tape, a nonvolatile memory card, or a ROM may be used.

The function of the above-described embodiments can be realized when a computer executes read program codes or when an operating system (OS) operated in the computer executes part or whole of actual processing based on the instructions of the program codes.

Further, the function of the above-described embodiments may be realized when the program codes read from the storage medium is written into a memory provided in an expansion board inserted into the computer or an expansion unit connected to the computer and then a CPU or the like provided in the expansion board or expansion unit executes part or whole of the processing based on the instructions of the program codes.

As described above, according to the present invention, even if a user does not have expert knowledge about data editing, he or she can edit video data by inserting a transition clip between scenes. Accordingly, even a user who is not familiar with data editing can create sophisticated video having a video effect.

While the present invention has been described with reference to what are presently considered to be the preferred embodiments, it is to be understood that the invention is not limited to the disclosed embodiments. On the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An information processing method for editing input data, comprising:
an obtaining step of obtaining metadata of the data;
a selecting step of selecting a transition clip used for adding a transition effect to the data based on the metadata; and
a processing step of adding a transition effect to the data by using the transition clip.

2. An information processing method according to claim 1, wherein the selecting step comprises:
an extracting step of extracting a plurality of potential transition clips suitable for adding a transition effect to the data from among transition clips stored in advance; and
a determining step of determining an optimal transition clip from among the plurality of extracted potential transition clips.

3. An information processing method according to claim 2, wherein the extracting step comprises a step of extracting a plurality of potential transition clips associated with event information of metadata included in two scenes sandwiching a position for a transition clip among all scenes in the data.

4. An information processing method according to claim 2, wherein the extracting step comprises a step of extracting a plurality of potential transition clips corresponding to a transition effect associated with the correlation between event information and object information of metadata included in two scenes sandwiching a position for a transition clip among all scenes in the data.

5. An information processing method according to claim 2, wherein the determining step comprises:
a step of displaying the plurality of extracted potential transition clips; and
a step of specifying an arbitrary transition clip from among the displayed potential transition clips,
whereby the specified transition clip is determined as an optimal transition clip.

6. An information processing method according to claim 1, wherein the selecting step comprises:
an extracting step of extracting transition clips which are unsuitable for adding a transition effect to the data from among transition clips stored in advance; and
a determining step of determining an optimal transition clip using the extracted unsuitable transition clips.

7. An information processing method according to claim 6, wherein the extracting step comprises a step of extracting a plurality of unsuitable transition clips associated with event information of metadata included in two scenes sandwiching a position for a transition clip among all scenes in the data.

8. An information processing method according to claim 6, wherein the extracting step comprises a step of extracting a plurality of unsuitable transition clips corresponding to a transition effect associated with the correlation between event information and object information of metadata included in two scenes sandwiching a position for a transition clip among all scenes in the data.

9. An information processing method according to claim 6, wherein the determining step comprises:
a step of displaying a plurality of potential transition clips;
a step of specifying an arbitrary transition clip from among the displayed potential transition clips; and
a step of displaying an error message when the specified transition clip is an unsuitable transition clip extracted in the extracting step.

10. An information processing method according to claim 1, wherein the selecting step comprises:
a step of calculating suitability of each transition clip for frames to be edited in the data;
a step of displaying the transition clips in decreasing order of suitability; and
a step of specifying an arbitrary transition clip from among the displayed transition clips.

11. An information processor for editing input data, comprising:
obtaining means for obtaining metadata of the data;
selecting means for selecting a transition clip used for adding a transition effect to the data based on the metadata; and
processing means for adding a transition effect to the data by using the transition clip.

12. A control program for allowing a computer to realize the information processing method according to any one of claims 1 to 10.
